(19) United States
(12) Patent Application Publication
(10) Pub. No.: US 2004/0251819 A1
(43) Pub. Date: Dec. 16, 2004

(54) Light emitting device and method for fabricating the same

(75) Inventor: Wei-Chieh Hsueh, Tainan (TW)

Correspondence Address: BACON & THOMAS, PLLC, 625 SLATERS LANE, FOURTH FLOOR, ALEXANDRIA, VA, 22314

(73) Assignee: Toppoly Optoelectronics Corp., Miao-Li (TW)

(21) Appl. No.: 10/458,247

(22) Filed: Jun. 11, 2003

(51) Int. Cl. H01J 9/00; H05B 33/00; H05B 33/10

(52) U.S. Cl. 313/506; 313/500; 313/509; 445/24

(57) ABSTRACT

A method for fabricating a light emitting device to be used for illuminating many kinds of luminous materials comprises the following steps. Firstly, an anode is provided. Then, an insulating layer is partially formed on a surface of the anode to define a plurality of light-emitting regions on the surface of the anode, wherein the plurality of light-emitting regions are uncovered by the insulating layer. Then, the many kinds of luminous materials are formed on corresponding light-emitting regions and the insulating layer so as to form a luminous material layer. Afterwards, a cathode is formed on the luminous material layer. The light emitting device produced by such method is also provided.

### FIELD OF THE INVENTION

The present invention relates to a light emitting device, and more particularly to a light emitting device with a light-emitting region defined by an insulating layer. The present invention also relates to a method for fabricating such light emitting device.

### BACKGROUND OF THE INVENTION

With increasing development of digital technology, panel displays become essential components of many electrical appliances such as notebooks, mobile phones, information appliances (IA) and personal digital assistants (PDA). Lightness, thinness and/or low electricity consumption are basic requirements of typical panel displays. However, depending on viewing angles, brightness, high image quality and stability on temperature, related art are required to be further developed. An organic light-emitting device (OLED) has been developed as a new technology for the next generation of panel displays due to its properties of self-light-emitting (without using a backlight), wider viewing angle, rapid response, simple manufacturing process and low energy consumption.

Please refer to FIG. 1. A typical two-transistor organic light-emitting device pixel (2T OLED pixel) principally comprises a select transistor 11, a capacitor 12, a drive transistor 13 and an organic light-emitting device 14. FIG. 2 is a cross-sectional view showing the drive transistor and pixels of the organic light-emitting device. The drive transistor 13 is used to provide driving current to the organic light-emitting device 14 so as to emit light. The configuration of the drive transistor and the working principle of the organic light-emitting device are well known in the art and need not be further described in detail herein. The organic light-emitting device 14 principally an anode 141, a luminous material layer 142 and a cathode 143. The anode 141 is usually made of indium tin oxide (ITO) transparent conductive film. The luminous material layer 142 is formed on the anode 141 by means of an evaporation process. The cathode 143, which is made of a material selected from aluminum (Al), magnesium (Mg), calcium (Ca), lithium (Li) or other metals, is formed on the luminous material layer 142 by means of an electroplating process. The source terminal 131 of the drive transistor 13 is electrically connected to the anode 141.

Since the OLED technology has not been well established, some problems occur when commercialized. For example, the luminous materials used have problems of insufficient emitting efficiency. The common luminous materials are divided into three types, i.e. R (red), G (green), and B (blue), respectively. The green luminous materials are known to have satisfactory emitting efficiency, whereas the emitting efficiencies of the green and red luminous materials are somewhat deteriorated. Therefore, it is required to compensate such deterioration. One compensating method is based on a concept of increasing applied voltage, for example augmenting a relatively higher voltage and a relatively lower voltage to the red luminous materials and the blue luminous materials, respectively. However, the increase of applied voltage will accelerate aging of the luminous materials so as to reduce lifetime of the product using such luminous materials. However, a much higher voltage is required to compensate emitting efficiency as the using period prolongs, which is more power-consumed.

Furthermore, as shown in FIG. 3, since the luminous material layer for example made of R (red), G (green) and B (blue) luminous materials is formed on the anode by an evaporation process, a shadow mask 15 is employed to align theses luminous materials so as to define light-emitting regions 16. However, due to influence of heat conductivity and metal tension, the luminous material layer does not have good alignment precision by using the shadow mask. More particularly, in some cases where the shadow mask is shifted, the light-emitting regions of all sub-pixels are shrunk accordingly, which impairs image quality of the OLED device.

### SUMMARY OF THE INVENTION

It is an object of the present invention to provide a light emitting device and a method for fabricating such light emitting device to avoid the shrunk light-emitting regions of sub-pixels.

It is an object of the present invention to provide a light emitting device and a method for fabricating such light emitting device to effectively compensate the light-emitting efficiencies of different luminous materials.

According to a first aspect of the present invention, there is provided a method for fabricating a light emitting device to be used for illuminating many kinds of luminous materials. Firstly, an anode is provided. Then, an insulating layer is partially formed on a surface of the anode to define a plurality of light-emitting regions on the surface of the anode, wherein the plurality of light-emitting regions are uncovered by the insulating layer. Then, the many kinds of luminous materials are formed on corresponding light-emitting regions and the insulating layer so as to form a luminous material layer. Afterwards, an cathode is formed on the luminous material layer.

In an embodiment, the many kinds of luminous materials are aligned on the light-emitting regions and the insulating layer by using a shadow mask, and the shadow mask has openings greater than those of the light-emitting regions.

In an embodiment, the plurality of light-emitting regions comprises many kinds of sub-regions with different areas, and magnitudes of the areas are determined by measuring emitting efficiencies of the many kinds of luminous materials under a specified applied voltage.

In an embodiment, the many kinds of luminous materials comprise a red luminous material, a green luminous material and a blue luminous material.

In an embodiment, the sub-regions corresponding to the red luminous material, the green luminous material and the blue luminous material have a first area, a second area and a third area, respectively, and the first area is greater than the third area, and the third area is greater than the second area.

In an embodiment, the step for defining the plurality of light-emitting regions is performed by a photolithography process.

In an embodiment, the step of forming the luminous material layer is performed by an evaporation process.

According to a second aspect of the present invention, there is provided a method for fabricating a light emitting device to be used for illuminating many kinds of luminous materials. Firstly, an anode is provided. Then, an insulating layer is partially formed on a surface of the anode to define a plurality of light-emitting regions on the surface of the anode, the plurality of light-emitting regions being uncovered by the insulating layer. The plurality light-emitting regions comprise many kinds of sub-regions with different areas, and magnitudes of the areas are determined by measuring emitting efficiencies of the many kinds of luminous materials under a specified applied voltage. Then, the many kinds of luminous materials are formed on corresponding light-emitting regions and the insulating layer so as to form a luminous material layer. Afterwards, a cathode is formed on the luminous material layer.

According to a second aspect of the present invention, there is provided a light emitting device for illuminating many kinds of luminous materials. The light emitting device comprises an anode, an insulating layer, a luminous material layer and a cathode. The insulating layer is partially disposed on a surface of the anode to define a plurality of light-emitting regions on the surface of the anode, wherein the plurality of light-emitting regions are uncovered by the insulating layer. The luminous material layer is disposed on the plurality of light-emitting regions and the insulating layer. The cathode is formed on the luminous material layer.

In an embodiment, the many kinds of luminous materials are aligned on the light-emitting regions and the insulating layer by using a shadow mask, and the shadow mask has openings greater than those of the light-emitting regions.

In an embodiment, the plurality light-emitting regions comprises many kinds of sub-regions with different areas, and magnitudes of the areas are determined by measuring emitting efficiencies of the many kinds of luminous materials under a specified applied voltage.

In an embodiment, the plurality of light-emitting regions and the luminous material layer are defined by a photolithography process and an evaporation process, respectively.

In an embodiment, the insulating layer is made of a material selected from a group consisting of silicon oxide, silicon nitride, silicon oxynitride and the combination thereof.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a typical two-transistor organic light-emitting device pixel;

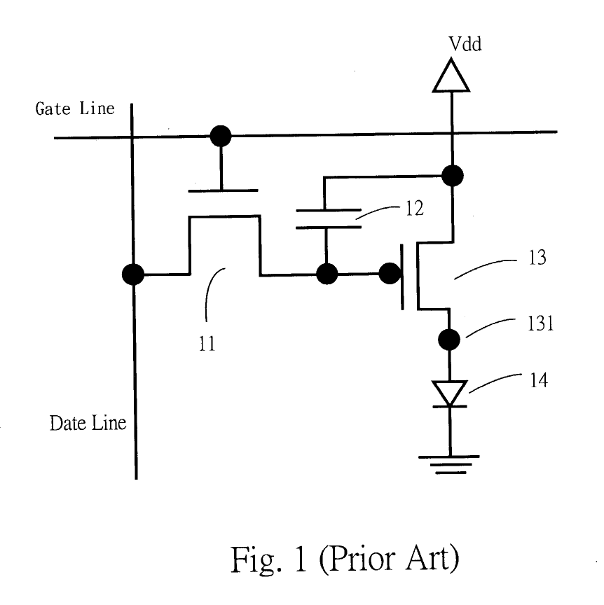

FIG. 2 is a sectional view illustrating an organic light-emitting device according to prior art;

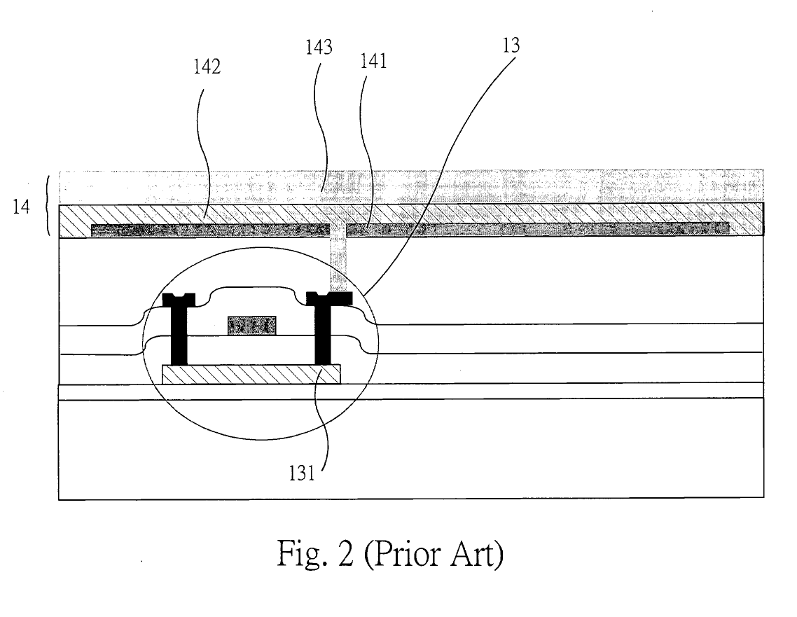

FIG. 3 schematically illustrates the light-emitting regions defined by a shadow mask according to prior art;

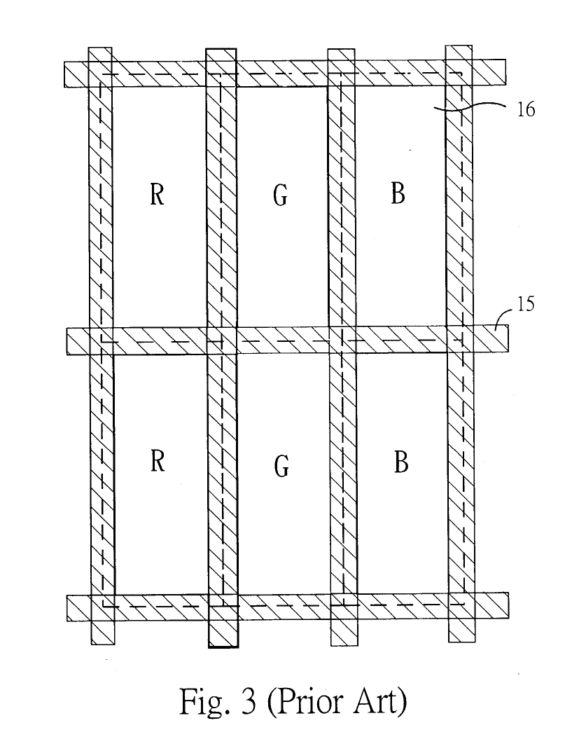

FIG. 4 illustrates a relationship between the emitting efficiencies and the areas of emitting regions for RGB luminous materials;

FIG. 5 is a sectional view illustrating an organic light-emitting device according to a preferred embodiment of the present invention; and

FIG. 6 schematically illustrates the light-emitting regions defined by an insulating layer according to the present invention.

### DETAILED DESCRIPTION OF THE PREFERRED EMBODIMENT

The light-emitting efficiency is influences by may factors such as types of luminous materials, applied voltage and areas of light-emitting regions. The luminous materials are expensive and related developments are not satisfied so far. As previously mentioned, although the increase of applied voltage facilitates increasing emitting efficiency of any luminous material, the problems of material aging and high power consumption could not be effectively solved. In order to avoid the above-mentioned problems in the prior art, the light emitting device of the present invention is fabricated on the basis of varying areas of light-emitting regions so as to compensate light-emitting efficiency.

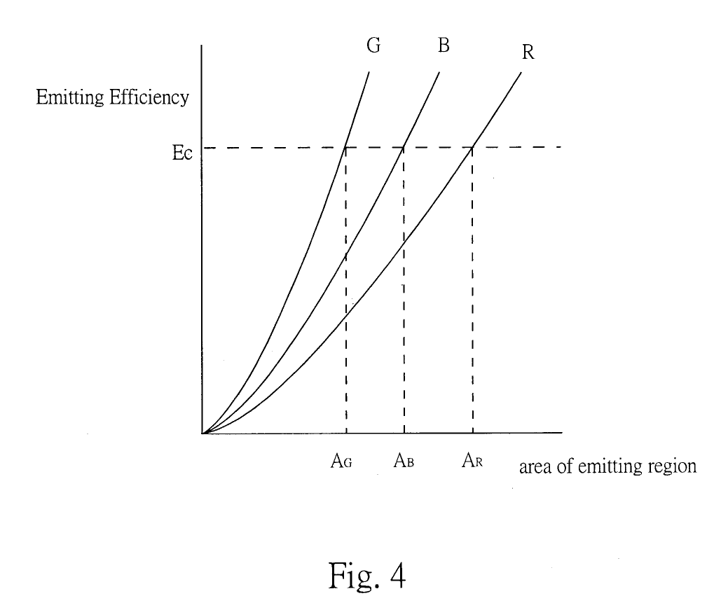

FIG. 4 illustrates a relationship between the emitting efficiencies and the areas of emitting regions for RGB luminous materials. Referring to FIG. 4, when a specified voltage is applied on each luminous material, the light emitting efficiency (E) is increased with the increase of area (A) of light-emitting regions. The light-emitting efficiency of the green luminous material (G) is higher than the blue luminous material (B), and the red luminous material (R) has the lowest light-emitting efficiency. Depending on fabricating cost and desired light-emitting quality, a target efficiency Ec is selected. Then, target areas A_{G}, A_{B} and A_{R} of light-emitting regions of green, blue and red luminous materials, respectively, are obtained accordingly. It is found that A_{G}<A_{B}<A_{R}.

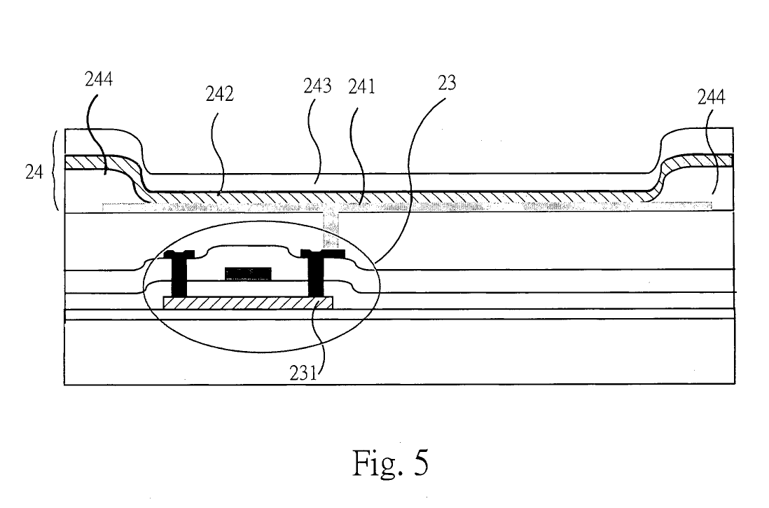

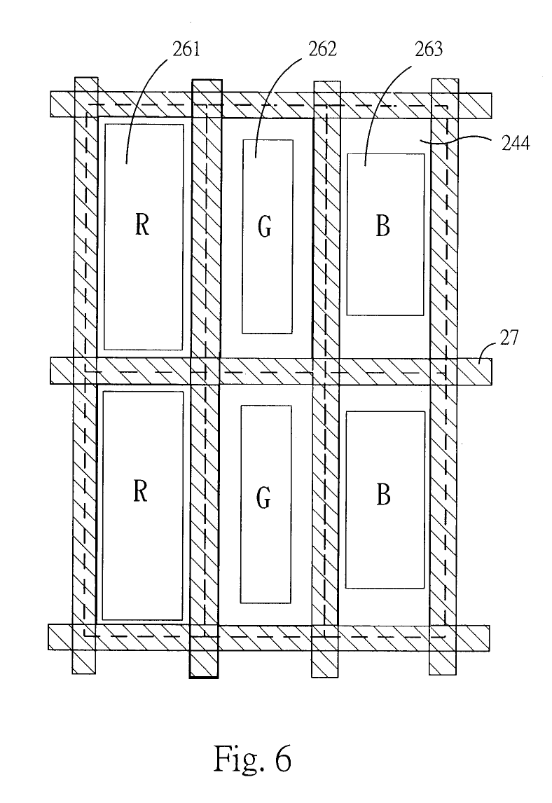

Please refer to FIG. 5. The organic light-emitting device 24 of the present invention principally an anode 241, a luminous material layer 242, a cathode 243 and an insulating layer 244. The source terminal 231 of the drive transistor 23 is electrically connected to the anode 241. Please refer to FIGS. 5 and 6, the steps for fabricating the organic light-emitting device suing RGB luminous materials according to the present invention will be illustrated as follows:

In step (a), a transparent conductive film made of for example indium tin oxide (ITO) is provided as the anode 241;

In step (b), the insulating layer 244 is partially formed on a surface of the anode 241 to define three kinds of light-emitting regions 261, 262 and 263 with different areas (A_{R}, A_{G} and A_{B}, where A_{G}<A_{B}<A_{R}) on the surface of the anode 241 by a photolithography process, wherein the insulating layer is made of a material preferably selected from silicon oxide, silicon nitride, silicon oxynitride and the combination thereof;

In step (c), the RGB luminous materials are formed by evaporation process and aligned on the corresponding light-emitting regions 261, 262 and 263 and the insulating layer 241 by using a shadow mask 27 so as to form a luminous material layer 242; and

In step (d), the cathode 243, which is made of a material selected from aluminum (Al), magnesium (Mg), calcium (Ca), lithium (Li) or other metals, is formed on the luminous material layer 242 by means of an electroplating process, for example.

As mentioned in the prior art, the light-emitting regions of all sub-pixels might be shrunk due to the inferior alignment precision by using the shadow mask. In the production of the present organic light-emitting device, however, the insulating layer 244 are defined as the light-emitting regions by photolithography, and then luminous materials are aligned by using the shadow mask 27. Since alignment precision by means of photolithography is much superior to the use of shadow mask and the shadow mask has openings greater than those of the light-emitting regions, the areas of all light-emitting regions could be unchanged even though the shadow mask is slightly shifted. Furthermore, by varying areas of light-emitting regions according to the present invention, the traditional problems of material aging and high power consumption on compensating light-emitting efficiency could be effectively avoided.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for fabricating a light emitting device to be used for illuminating many kinds of luminous materials, said method comprising steps of:
providing an anode;
forming an insulating layer partially on a surface of said anode to define a plurality of light-emitting regions on said surface of said anode, wherein said plurality of light-emitting regions are uncovered by said insulating layer;
forming said many kinds of luminous materials on corresponding light-emitting regions and said insulating layer so as to form a luminous material layer; and
forming a cathode on said luminous material layer.

2. The method according to claim 1 wherein said many kinds of luminous materials are aligned on said light-emitting regions and said insulating layer by using a shadow mask, and said shadow mask has openings greater than those of said light-emitting regions.

3. The method according to claim 1 wherein said plurality light-emitting regions comprises many kinds of sub-regions with different areas, and magnitudes of said areas are determined by measuring emitting efficiencies of said many kinds of luminous materials under a specified applied voltage.

4. The method according to claim 3 wherein said many kinds of luminous materials comprise a red luminous material or a green luminous material or a blue luminous material.

5. The method according to claim 4 wherein said sub-regions corresponding to said red luminous material, said green luminous material and said blue luminous material have a first area, a second area and a third area, respectively, and said first area is greater than said third area, and said third area is greater than said second area.

6. The method according to claim 1 wherein said step for defining said plurality of light-emitting regions is performed by a photolithography process.

7. The method according to claim 1 wherein said step of forming said luminous material layer is performed by an evaporation process.

8. A method for fabricating a light emitting device to be used for illuminating many kinds of luminous materials, said method comprising steps of:
providing an anode;
forming an insulating layer partially on a surface of said anode to define a plurality of light-emitting regions on said surface of said anode, said plurality of light-emitting regions being uncovered by said insulating layer, wherein said plurality light-emitting regions comprise many kinds of sub-regions with different areas, and magnitudes of said areas are determined by measuring emitting efficiencies of said many kinds of luminous materials under a specified applied voltage; and
forming said many kinds of luminous materials on corresponding light-emitting regions and said insulating layer so as to form a luminous material layer; and
forming an cathode on said luminous material layer.

9. The method according to claim 8 wherein said many kinds of luminous materials are aligned on said light-emitting regions and said insulating layer by using a shadow mask, and said shadow mask has openings greater than those of said light-emitting regions.

10. The method according to claim 8 wherein said many kinds of luminous materials comprise a red luminous material or a green luminous material or a blue luminous material.

11. The method according to claim 10 wherein said sub-regions corresponding to said red luminous material, said green luminous material and said blue luminous material have a first area, a second area and a third area, respectively, and said first area is greater than said third area, and said third area is greater than said second area.

12. The method according to claim 8 wherein said step for defining said plurality of light-emitting regions is performed by a photolithography process.

13. The method according to claim 8 wherein said step of forming said luminous material layer is performed by an evaporation process.

14. A light emitting device for illuminating many kinds of luminous materials, said light emitting device comprising:
an anode;
an insulating layer partially disposed on a surface of said anode to define a plurality of light-emitting regions on said surface of said anode, wherein said plurality of light-emitting regions are uncovered by said insulating layer;
a luminous material layer disposed on said plurality of light-emitting regions and said insulating layer; and
a cathode formed on said luminous material layer.

15. The light emitting device according to claim 14 wherein said many kinds of luminous materials are aligned on said light-emitting regions and said insulating layer by using a shadow mask, and said shadow mask has openings greater than those of said light-emitting regions.

16. The light emitting device according to claim 14 wherein said plurality light-emitting regions comprises many kinds of sub-regions with different areas, and magnitudes of said areas are determined by measuring emitting efficiencies of said many kinds of luminous materials under a specified applied voltage.

17. The light emitting device according to claim 16 wherein said may kinds of luminous materials comprises a red luminous material or a green luminous material or a blue luminous material.

18. The light emitting device according to claim 17 wherein said sub-regions corresponding to said red luminous material, said green luminous material and said blue luminous material has a first area, a second area and a third area, respectively, and said first area is greater than said third area, and said third area is greater than said second area.

19. The light emitting device according to claim 14 wherein said plurality of light-emitting regions and said luminous material layer are defined by a photolithography process and an evaporation process, respectively.

20. The light emitting device according to claim 14 wherein said insulating layer is made of a material selected from a group consisting of silicon oxide, silicon nitride, silicon oxynitride and the combination thereof.
